(19) United States
(12) Patent Application Publication
(10) Pub. No.: US 2014/0308552 A1
(43) Pub. Date: Oct. 16, 2014

(54) BATTERY PACK

(71) Applicant: Samsung SDI Co., Ltd., Yongin-si (KR)

(72) Inventors: Myung-Chul Kim, Yongin-si (KR); Hee-Joon Jin, Yongin-si (KR); Jang-Gun Ahn, Yongin-si (KR); Young-Bin Lim, Yongin-si (KR)

(73) Assignee: Samsung SDI Co., Ltd., Yongin-si (KR)

(21) Appl. No.: 14/185,870

(22) Filed: Feb. 20, 2014

(30) Foreign Application Priority Data
Apr. 15, 2013 (KR) 10-2013-0040987

(51) Int. Cl. H01M 2/36

(52) U.S. Cl. CPC H01M 2/36
USPC 429/82

(57) ABSTRACT

A battery pack includes: at least one battery module having a plurality of battery cells arranged in one direction; and a housing including a module accommodating portion for accommodating the battery module therein and a flange portion coupled to an entrance of the module accommodating portion, and the flange portion includes an inclined surface and a drainage port at the end of the inclined surface.

### CROSS-REFERENCE TO RELATED APPLICATION

This application claims priority to and the benefit of Korean Patent Application No. 10-2013-0040987, filed on Apr. 15, 2013, in the Korean Intellectual Property Office, the entire contents of which are incorporated herein by reference in their entirety.

### BACKGROUND

1. Field

An aspect of the present invention relates to a battery pack.

2. Description of Related Art

In general, battery cells may be used as energy sources for mobile devices, electric vehicles, hybrid vehicles and the like. The shape of a battery cell may be variously changed depending on the kind of external device to which the battery cell is applied.

In a case where long-time driving and high-power driving are required, such as in an electric vehicle or a hybrid vehicle which consumes a large amount of power, a large-capacity battery module may be configured by electrically coupling a plurality of battery cells in order to increase power and capacity. The output voltage or output current of the battery module may be increased according to the number of battery cells included in the battery module. In addition, a battery pack may be configured by electrically coupling multiple such battery modules.

However, a high-power and large-capacity battery pack may generate a large amount of heat in a charging/discharging process thereof. Therefore, the battery pack should be able to more easily dissipate heat generated in each battery cell. To this end, a cooling system may be formed in the high-power and large-capacity battery pack. The cooling system lowers the internal temperature of the battery pack by allowing a cooling medium such as air to flow into the battery pack at one side of the battery pack and be exhausted to the outside of the battery pack at the other side of the battery pack.

In a case where the humidity of the air flowed into the battery pack is higher (e.g., high), water may gather in an area (or a portion) of the battery pack at which the flow of the air is blocked in the battery pack. Therefore, if the water is not effectively removed, a short circuit may occur in the battery pack.

### SUMMARY

Embodiments of the present invention provide a battery pack which enables water generated due to higher-humidity (e.g., high-humidity) air flowed into the battery pack to be more easily discharged through an inclined surface of a flange portion in a housing and drainage ports formed at the end of the inclined surface.

According to an aspect of the present invention, a battery pack includes: at least one battery module having a plurality of battery cells arranged in one direction; and a housing including a module accommodating portion for accommodating the battery module therein and a flange portion coupled to an entrance of the module accommodating portion, and the flange portion includes an inclined surface and a drainage port at the end of the inclined surface.

The housing may further include a cover for covering the module accommodating portion and the flange portion.

The flange portion may further include a first stepped portion contacting the entrance of the module accommodating portion, and a second stepped portion opposite the first stepped portion and along an outer edge of the flange portion.

The inclined surface may be between the first and second stepped portions.

The inclined surface may be downwardly inclined from the first stepped portion to the second stepped portion.

The drainage port may be at the second stepped portion.

A bottom surface of the drainage port and the inclined surface may be coupled to be parallel with each other.

The first stepped portion and the inclined surface may meet at a boundary, and when a height from the boundary to a cover of the housing is denoted as H1, and a height from a bottom surface of the drainage port to the cover is denoted as H2, H1 and H2 may have a relation of H1<H2.

The drainage port may traverse the second stepped portion in a direction perpendicular to a direction in which a corresponding portion of the flange portion extends.

The drainage port may include a first drainage portion at which the width of the drainage port is constant, and a second drainage portion at which the width of the drainage port is expanded.

The first drainage portion may be coupled to an outer edge of the second stepped portion, and the second drainage portion may extend from the first drainage portion so as to be coupled to the inclined surface.

The second drainage portion may be formed so that the width from the first drainage portion to the inclined surface is widened.

The width of the drainage port from the outer edge of the second stepped portion toward the first stepped portion may be widened.

A drain coupled to the drainage port to discharge water to the outside of the housing may be in the flange portion.

The drain may be coupled to a portion of the drainage port.

The battery pack may further include a fastening portion for fastening the cover and the flange portion to each other.

As described above, according to an aspect of the present invention, water generated due to higher-humidity (e.g., high-humidity) air flowed into the battery pack can be more easily discharged through the inclined surface of the flange portion in the housing and the drainage ports formed at the end of the inclined surface, thereby improving the safety of the battery pack.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be more thorough and complete, and will more fully convey the scope of the example embodiments to those skilled in the art.

In the drawing figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is a perspective view of a battery pack according to an embodiment of the present invention.

FIG. 2 is an exploded perspective view of the battery pack of FIG. 1 according to an embodiment of the present invention.

FIG. 3 is a sectional view taken along the line A-A′ of FIG. 1.

FIG. 4 is a plan view showing a module accommodating portion according to an embodiment of the present invention.

FIG. 5A is an enlarged view of portion B of FIG. 4, for illustrating a further embodiment of the present invention.

FIG. 5B is an enlarged view of portion B of FIG. 4, for illustrating a further embodiment of the present invention.

FIG. 6 is a perspective view illustrating a plurality of battery cells accommodated in a battery module according to an embodiment of the present invention.

### DETAILED DESCRIPTION

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “coupled to” or “connected to” another element, it can be directly coupled to or connected to the another element or be indirectly coupled to or connected to the another element with one or more intervening elements interposed therebetween. Hereinafter, like reference numerals refer to like elements. In the drawings, the thickness or size of layers may be exaggerated for clarity and are not necessarily drawn to scale.

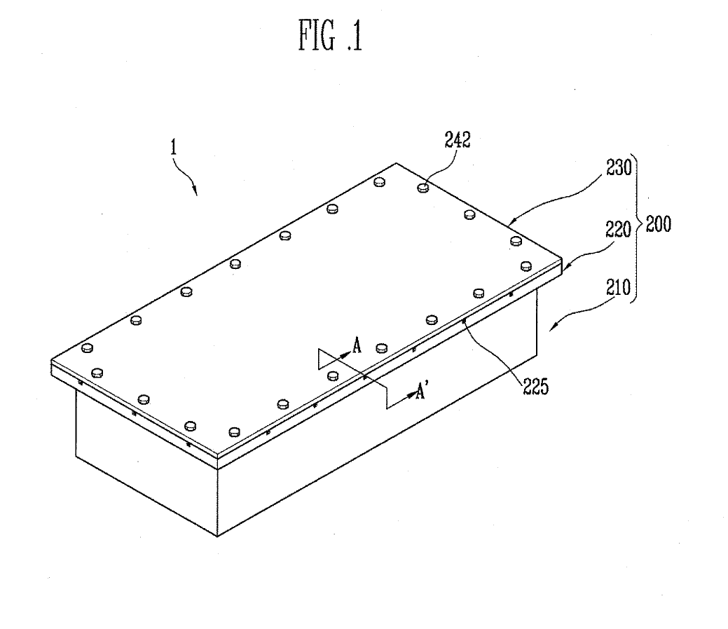

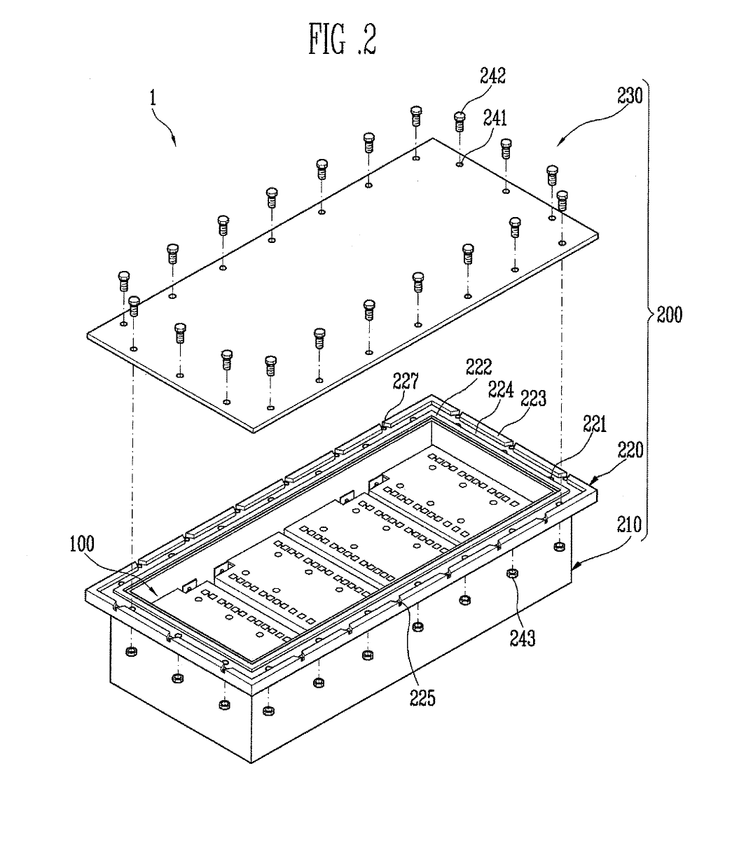

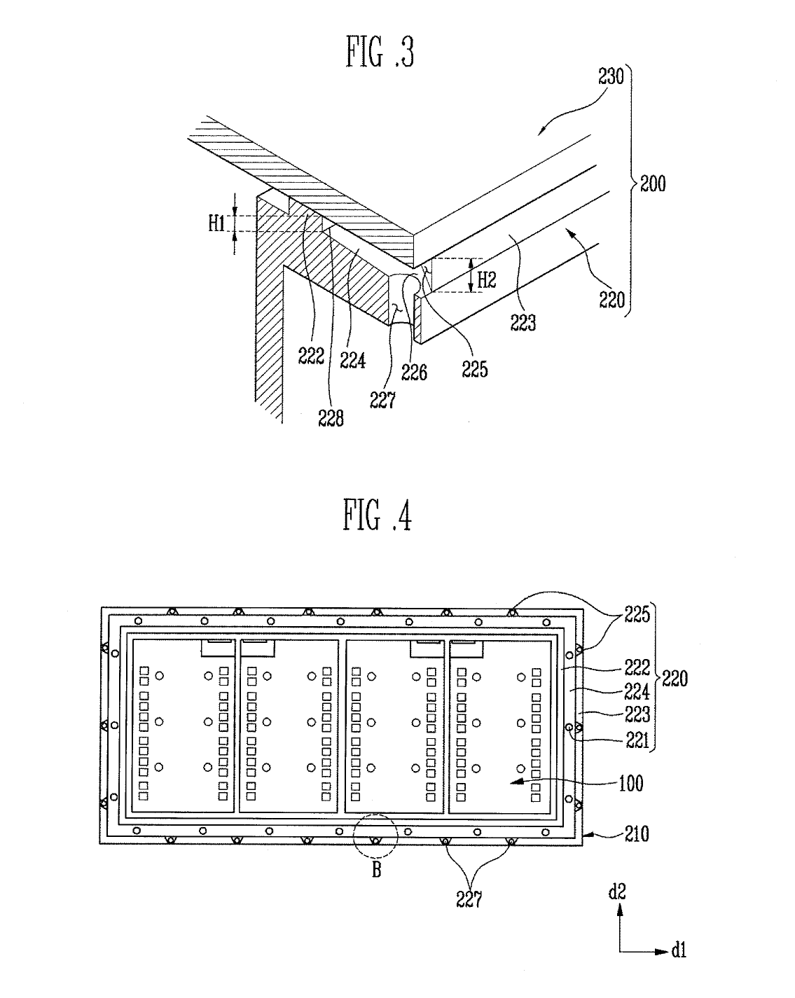

FIG. 1 is a perspective view of a battery pack according to an embodiment of the present invention. FIG. 2 is an exploded perspective view of the battery pack of FIG. 1 according to an embodiment of the present invention. FIG. 3 is a sectional view taken along the line A-A′ of FIG. 1.

Referring to FIGS. 1 and 2, the battery pack 1 according to an embodiment includes at least one battery module 100 in which a plurality of battery cells 10 (see FIG. 6) are arranged in one direction; and a housing 200 having a module accommodating portion 210 accommodating the battery module 100 therein and a flange portion 220 provided to be coupled to an entrance (or opening) of the module accommodating portion 210. An inclined surface 224 is formed in the flange portion 220, and drainage ports 225 are formed at the end of the inclined surface 224 (e.g., at an outer edge of the flange portion 220).

The housing 200 further includes a cover 230 covering the module accommodating portion 210 and the flange portion 220. The cover 230 and the flange portion 220 may be fastened by a fastening portion. In one embodiment, for the purpose of the fastening between the cover 230 and the flange portion 220, a plurality of cover fastening holes 241 are formed in the cover 230, and a plurality of flange portion fastening holes 221 are formed in the inclined surface 224. A bolt-shaped first fastening member 242 is inserted into the cover fastening hole 241 and the flange portion fastening hole 221 and is fastened to a second fastening member 243, so that the cover 230 and the flange portion 220 can be fastened to each other.

The flange portion 220 further includes a first stepped portion 222 and a second stepped portion 223. The first stepped portion 222 contacts the entrance of the module accommodating portion 210, and may have a predetermined height. The second stepped portion 223 is provided opposite to the first stepped portion 222 along the outside (or outer edge) of the flange portion 220, and may have a predetermined height.

The flange portion 220 will be described in detail with reference to FIG. 3. The inclined surface 224 of the flange portion 220 is formed between the first stepped portion 222 and the second stepped portion 223. In one embodiment, the inclined surface 224 is inclined to be gradually lowered toward the second stepped portion 223 from the first stepped portion 222. For example, the inclined surface 224 may be downwardly inclined toward the second stepped portion 223 from the first stepped portion 222. The drainage port 225 is formed at the second stepped portion 223, and a bottom surface 226 of the drainage port 225 and the inclined surface 224 are coupled to be parallel with each other.

According to an embodiment, as the inclined surface 224 is formed between the first and second stepped portions 222 and 223, the height (or length) from the bottom of the second stepped portion 223 to the cover 230 is greater than that from the bottom of the first stepped portion 222 to the cover 230. For example, the first stepped portion 222 and the inclined surface may meet at a boundary 228. When the height (or length) from the boundary 228 to the cover 230 is denoted as H1, and the height (or length) from the bottom surface 226 of the drainage port 225 to the cover 230 is denoted as H2, H1 and H2 have a relation of H1<H2. A drain 227 coupled to each drainage port 225 so as to discharge water to the outside of the housing 200 may be further formed in the flange portion 220.

In the structure of an existing battery pack, there may be a problem in that external water from the outside flows into a drainage port formed to discharge water to the outside of a housing. However, in embodiments of the present invention, the inclined surface 224 is formed downwardly inclined to the drainage port 225, so that even if external water flows into the housing 200, the water is more completely discharged to the drainage port 225. Further, at least one portion of the drainage port 225 may be formed in an expanded shape, so that it is possible to reduce the inflow of water, which may be caused by a capillary phenomenon.

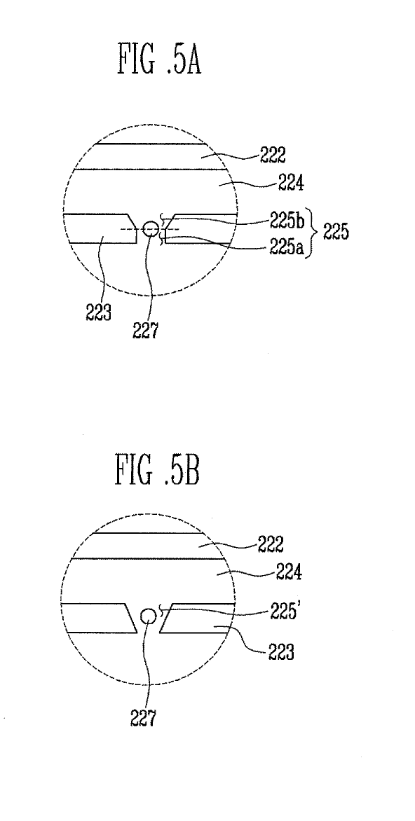

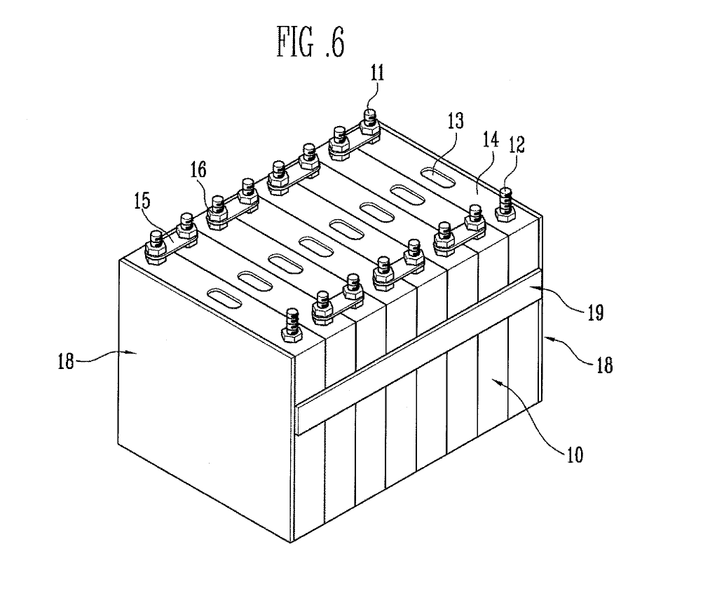

FIG. 4 is a plan view showing a module accommodating portion according to an embodiment of the present invention. FIG. 5A is an enlarged view of portion B of FIG. 4, for illustrating a further embodiment of the present invention. FIG. 5B is an enlarged view of portion B of FIG. 4, for illustrating a further embodiment of the present invention.

Referring to FIG. 4, when a direction in which a portion of the flange portion having a drainage port extends is referred to as a first direction d1, and the direction perpendicular to the first direction d1 is referred to as a second direction d2, the drainage port 225 is formed so that the direction in which the drainage port 225 traverses the second stepped portion 223 is parallel with the second direction d2.

Referring to FIG. 5A, a drainage port 225 according to an embodiment of the present invention is formed to include a first drainage portion 225a at which the width of the drainage port 225 is constant and a second drainage portion 225b at which the width of the drainage port 225 is expanded. In one embodiment, the first drainage portion 225a is coupled to the end of the second stepped portion 223 (e.g., at an outer edge of the second stepped portion 223), and the second drainage portion 225b is extended from the first drainage portion 225a so as to be coupled to the inclined surface 224. The second drainage portion 225b is formed so that the width from the first drainage portion 225a to the inclined surface 224 is widened. As described above, the drain 227 coupled to the drainage port 225 so as to discharge water to the outside of the housing 200 (see FIG. 2) may be further formed in the flange portion 220. In one embodiment, the drain 227 may be formed to be coupled to a portion of the drainage port 225.

Referring to FIG. 5B, a drainage port 225′ according to another embodiment of the present invention is formed so that the width from the outside (e.g., outer edge) of the second stepped portion 223 to (or toward) the first stepped portion 222 is widened. As described above, the drain 227 coupled to the drainage port 225 so as to discharge water to the outside of the housing 200 (see FIG. 2) may be further formed in the flange portion 220. In one embodiment, the drain 227 may be formed to be coupled to a portion of the drainage port 225.

FIG. 6 is a perspective view illustrating a plurality of battery cells accommodated in a battery module according to an embodiment of the present invention.

Referring to FIG. 6, in order to output higher power, a plurality of battery modules 100 according to embodiments of the present invention are coupled to one another and may be used as one set. Each battery module 100 is formed by arranging a plurality of battery cells 10 in one direction. The battery cells 10 are electrically coupled to one another, and each battery cell 10 may include a battery case having one opened surface, and an electrode assembly and an electrolyte, accommodated in the battery case.

The electrode assembly and the electrolyte generate energy through an electrochemical reaction therebetween, and the battery case is sealed with a cap plate 14. The cap plate 14 may be provided with terminal portions 11 and 12 and a vent portion 13. The terminal portions 11 and 12 may include positive and negative electrode terminals 11 and 12 respectively having different polarities. The vent portion 13 is a safety means of the battery cell 10, and acts as a passage through which gas generated inside the battery cell 10 is exhausted to the outside of the battery cell 10. The positive and negative electrode terminals 11 and 12 of adjacent battery cells 10 may be electrically coupled to each other through a bus-bar 15. The bus-bar 15 may be fixed to the positive and negative electrode terminals 11 and 12 by a member such as a nut 16.

The battery cell 10 may be configured by being arranged in plural numbers. For example, one or more plates 18 and 19 may be used to arrange (or fix the arrangement of) the battery cells 10. The plates 18 and 19 may include a pair of end plates 18 provided opposite to each other so as to face wider (or wide) surfaces of the battery cells 10, and a side plate 19 coupled to the end plates 18 so as to face narrower side surfaces of the battery cells 10. The plates 18 and 19 may be used to arrange (or fix) the plurality of battery cells 10, and may be variously modified according to the design of the battery module 100.

Example embodiments have been disclosed herein, and although specific terms may be employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims and their equivalents.

What is claimed is:

1. A battery pack, comprising:
at least one battery module having a plurality of battery cells arranged in one direction; and
a housing comprising a module accommodating portion for accommodating the battery module therein and a flange portion coupled to an entrance of the module accommodating portion,
wherein the flange portion comprises an inclined surface and a drainage port at the end of the inclined surface.

2. The battery pack of claim 1, wherein the housing further comprises a cover for covering the module accommodating portion and the flange portion.

3. The battery pack of claim 1, wherein the flange portion further comprises a first stepped portion contacting the entrance of the module accommodating portion, and a second stepped portion opposite the first stepped portion and along an outer edge of the flange portion.

4. The battery pack of claim 3, wherein the inclined surface is between the first and second stepped portions.

5. The battery pack of claim 3, wherein the inclined surface is downwardly inclined from the first stepped portion to the second stepped portion.

6. The battery pack of claim 3, wherein the drainage port is at the second stepped portion.

7. The battery pack of claim 1, wherein a bottom surface of the drainage port and the inclined surface are coupled to be parallel with each other.

8. The battery pack of claim 3, wherein the first stepped portion and the inclined surface meet at a boundary, and when a height from the boundary to a cover of the housing is denoted as H1, and a height from a bottom surface of the drainage port to the cover is denoted as H2, H1 and H2 have a relation of H1<H2.

9. The battery pack of claim 3, wherein the drainage port traverses the second stepped portion in a direction perpendicular to a direction in which a corresponding portion of the flange portion extends.

10. The battery pack of claim 1, wherein the drainage port comprises a first drainage portion at which the width of the drainage port is constant, and a second drainage portion at which the width of the drainage port is expanded.

11. The battery pack of claim 10, wherein the first drainage portion is coupled to an outer edge of the second stepped portion, and the second drainage portion extends from the first drainage portion so as to be coupled to the inclined surface.

12. The battery pack of claim 10, wherein the second drainage portion is formed so that the width from the first drainage portion to the inclined surface is widened.

13. The battery pack of claim 3, wherein the width of the drainage port from the outer edge of the second stepped portion toward the first stepped portion is widened.

14. The battery pack of claim 1, wherein a drain coupled to the drainage port to discharge water to the outside of the housing is in the flange portion.

15. The battery pack of claim 14, wherein the drain is coupled to a portion of the drainage port.

16. The battery pack of claim 2, further comprising a fastening portion for fastening the cover and the flange portion to each other.
